(19) United States
(12) Patent Application Publication
(10) Pub. No.: US 2018/0232920 A1
(43) Pub. Date: Aug. 16, 2018

(54) CONTEXTUALLY AWARE LOCATION SELECTIONS FOR TELECONFERENCE MONITOR VIEWS

(71) Applicant: Microsoft Technology Licensing, LLC, Redmond, WA (US)

(72) Inventors: Jason Thomas Faulkner, Seattle, WA (US); Catherine Bassova, Sammamish, WA (US); Thaddeus A. Scott, Kirkland, WA (US); Marcelo Daniel Truffat, Bothell, WA (US); Mansoor Malik, Redmond, WA (US); Amey Parandekar, Redmond, WA (US); Kevin D. Morrison, Arlington, MA (US)

(21) Appl. No.: 15/430,429

(22) Filed: Feb. 10, 2017

(51) Int. Cl. G06T 11/60; H04N 7/15; H04L 29/06

(52) U.S. Cl. CPC G06T 11/60; H04N 7/15; G06T 2200/24; H04L 65/1069; H04L 65/403

(57) ABSTRACT

Systems and methods for providing contextually aware location selections for teleconference monitor views are presented. A system can be configured to provide different user interfaces with each user interface associated with a category of functionality. For instance, one user interface may provide document editing functionality for editing a document, and another user interface may provide instant messaging functionality. When a user is engaged in a teleconference session, techniques presented herein enable a system to dynamically select a location for rendering of the teleconference session depending on the category of functionality being utilized by the user. A size and display properties of a display are of the teleconference session can also be determined based on a selected category of functionality.

### BACKGROUND

Communication and collaboration are key aspects in people's lives, both socially and in business. Communication and collaboration tools have been developed with the aim of connecting people to share experiences. In many cases, the aim of these tools is to provide, over a network, an experience which mirrors real life interaction between individuals and groups of people. Interaction is typically provided by audio and/or visual elements.

Such tools include instant messaging, voice calls, video calls, group chat, shared desktop, shared media and content, shared applications, etc. These tools can perform capture, manipulation, transmission and reproduction of audio and visual elements, and use various combinations of such elements in an attempt to provide a collaborative environment. A user can access such tools to create a teleconference session with multiple users by the use of a laptop or desktop computer, mobile phone, tablet, games console, etc. Such devices can be linked in a variety of possible network architectures, such as peer-to-peer architectures or client-server architectures or a hybrid, such as a centrally managed peer-to-peer architecture.

When a user participates in a teleconference session, some current technologies can leave much to be desired. For example, in some existing programs, when participants of a teleconference session desire to interact with certain types of content, such as a document or spreadsheet, users often need to open a separate window or a completely different program. This issue also exists when users wish to conduct a private chat session with certain users, particularly when they wish to engage in a private chat session with users that are not participants of a teleconference session. In any arrangement where a user is required to switch to a different window or a completely different program to conduct a task, a participant's attention is diverted from the contents of the teleconference session. While a user is engaged with other user interfaces or other programs, important subject matter communicated in the teleconference session may be missed or overlooked. Even worse, such distractions of one participant can reduce the overall engagement of all session participants. It is with respect to these and other considerations that the disclosure made herein is presented.

### SUMMARY

The techniques disclosed herein assist in enabling participants to remain engaged in a teleconference session while performing different tasks that may cause the main view of the teleconference session to be obscured. For example, using the techniques described herein, a user can “multi-task” while participating in a teleconference session. During the teleconference session, the participant can multi-task by interacting with files, emails, calendars, participating in chat discussions, web browsing, as well as accessing functionality provided by the teleconference service and/or other programs. As used herein, the term “multi-task” refers to a user accessing a different category of functionality compared to the category of functionality associated with the control of the teleconference session. In some examples, when a participant accesses a category of functionality that causes a different graphical user interface to be displayed in place of the teleconference graphical user interface. When the user accesses a category of functionality or a completely different software application to conduct a task outside of a teleconference session, the user is considered to be “multi-tasking.” Generally, while “multi-tasking,” a participant's attention can be diverted from the contents of the teleconference session. Using techniques described herein, a teleconference monitor view displaying aspects of a teleconference session is displayed along with content related to the other task the user is performing. In addition, a location for the teleconference monitor view is dynamically selected depending on the task the user is performing and/or the arrangement of the content related to the other task.

During a teleconference session, streams are received from a plurality of client computing devices at a server. The streams can be combined by the server to generate teleconference data defining aspects of a teleconference session. The teleconference data can comprise individual data streams, also referred to herein as “streams,” which can comprise content streams or participant streams. The participant streams include video of one or more participants. The content streams may include video or images of files, data structures, word processing documents, formatted documents (e.g. PDF documents), spreadsheets, or presentations. The content streams include streams that are not participant streams. In some configurations, the participant streams can include video data, and in some configurations audio data, streaming live from a video camera connected to the participant's client computing device. In some instances, a participant may not have access to a video camera and may communicate a participant stream comprising an image of the participant, or an image representative of the participant, such as, for example, an avatar. The teleconference data and/or the streams of the teleconference data can be configured to cause a computing device to generate a user interface comprising a display area for rendering one or more streams of the teleconference data.

The teleconference data is configured to cause at least one client computing device of the plurality of client computing devices to render a first user interface, when the user is not multi-tasking, that displays one or more of the streams within a first view (the “stage view”). When the user is multi-tasking, a second user interface (a “multi-tasking view”) is rendered, which can display content associated with the multi-tasking, that replaces the stage view.

A teleconference monitor view displaying aspects of a teleconference session can be displayed concurrently with the multi-tasking view such that the participant stays engaged with the teleconference session while also interacting with different categories of functionality provided by the teleconference service and/or some other application or service. In some configurations, the teleconference service may provide users with many different tools that are associated with different categories of functionality. For example, the teleconference service may provide a first category of functionality that is associated with managing a teleconference session, a second category of functionality that is associated with electronic messaging, a third category of functionality that is associated with document viewing and/or editing, a fourth category of functionality that is associated with managing a calendar, a fifth category of functionality that is associated with a chat service, and the like. In other configurations, a user might access different categories of functionality that are associated with other applications and/or services. For example, a user might access a category of functionality that is associated with a WEB browser, an email application, a mapping service, a music application, a video application, and the like.

Enabling a participant of a teleconference session to access different categories of functionality (e.g., tools for selecting, viewing, and modifying various forms of content) while simultaneously viewing one or more streams of the teleconference session keeps participants engaged in the session while enabling users to multi-task. For illustrative purposes, the one or more streams of the teleconference session can be displayed within a teleconference monitor view, which may be a graphical user interface element, e.g., a thumbnail. Such features, as will be described in more detail below, increase a user's productivity and the overall efficiency of human interaction with a computing device.

In some examples, when the user is navigating other functionality provided by the teleconference system or accessing other functionality provided by a different application, at least a portion of the one or more streams can be rendered within a teleconference monitor view that is displayed within a user interface on a portion of the display in addition to the display of content associated with the other category of functionality. In some examples, the teleconference monitor view can be displayed within a user interface element that is associated with the other category of functionality. For instance, a video stream of the participant can be displayed within a chat bar menu area when a user is accessing the category of functionality associated with the chat program.

According to some examples, the location of where to render the teleconference monitor view can be based on the selected category of functionality. In some configurations, the teleconference service can position the teleconference monitor view based on the locations of the displayed user interface elements and content associated with the multi-tasking view for the selected category of functionality. For example, when the user selects chat functionality, the teleconference monitor view may be placed within an area of the menu bar that does not include other content. Similarly, when the user selects contact functionality such as an address book, the teleconference monitor view can be placed in a position that does not obscure the address information, phone controls, and the like. In some configurations, a default location can be associated with each of the different categories of functionality. In other examples, the location can be based on an analysis of the content that is displayed as a result of the user selecting the category of functionality.

According to some techniques, the teleconference system performs a graphical analysis of the screen presenting the multi-tasking view to identify areas on the display that do not include selectable user interface elements (e.g., control buttons, selectors, scroll bars, and the like) or are areas of the display that do not include other types of content that the user may want to view (e.g., text, drawings, graphs). When there is an area of the multi-tasking view that is identified to not include user interface controls and/or other content, the teleconference system can render the teleconference monitor view at this location. In some examples, a default location can be used to render the teleconference monitor view.

In one illustrative example, a stream of selected media content, such as a video stream of a current participant presenting in the teleconference session, and/or a video stream of content currently being presented in the teleconference session can be displayed in a graphical user interface of the teleconference monitor view while the user interacts with other functionality. For example, one user can select a file, such as a PowerPoint file, and independently view the contents of the selected file while staying engaged with the displayed video stream of the teleconference session that is presented in the teleconference monitor view. As another example, another user can start a chat session while still being able to view the current presenter and/or content within the teleconference monitor view. In some examples, the teleconference monitor view is presented within a thumbnail user interface element that can be located based on the category of functionality associated with the task being performed by the user. In other examples, the teleconference monitor view is presented within a user interface element associated with the different category of functionality. Thus, even when a presenter of the teleconference session is displaying a particular slide of the PowerPoint file, other users can browse through other slides, and even possibly edit the file, during the presentation. In addition, the user can engage with multiple message forums, e.g., a channel forum or a chat forum, while staying engaged with the video streams of a teleconference session. By the use of the techniques disclosed herein, a user can utilize the different categories of functionality provided by different program modules while also viewing a video stream of a presenter or material shared by the presenter within a teleconference session.

This Summary is provided to introduce a selection of concepts in a simplified form that are further described below in the Detailed Description. This Summary is not intended to identify key or essential features of the claimed subject matter, nor is it intended to be used as an aid in determining the scope of the claimed subject matter. The term “techniques,” for instance, may refer to system(s), method(s), computer-readable instructions, module(s), algorithms, hardware logic, and/or operation(s) as permitted by the context described above and throughout the document.

### BRIEF DESCRIPTION OF THE DRAWINGS

FIG. 1 is a block diagram of an example of a teleconference system.

FIG. 2 is a block diagram of an example of the device in the teleconference system of FIG. 1.

FIG. 3A is a screenshot view of a display corresponding to one of the client computing devices in a teleconference session illustrating a first user interface arrangement that presents the teleconference session view for a teleconference session.

FIGS. 3B and 3C are screenshot views of a display corresponding to one of the client computing devices in the teleconference session illustrating a transition to a multi-tasking view concurrently displayed with a teleconference monitor view.

FIGS. 3D, 3E, and 3F are screenshot views of a display corresponding to one of the client computing devices in the teleconference session illustrating the teleconference monitor view presented in different areas of the display and/or which are sized differently.

FIG. 3G is a screenshot view of a display corresponding to one of the client computing devices in the teleconference session illustrating a landscape view of the teleconference monitor view.

FIG. 3H is a screenshot view of a display corresponding to one of the client computing devices in the teleconference session illustrating the transition to the teleconference monitor view in which the teleconference monitor view is presented within a section of a user interface where multi-tasking content is also displayed.

FIG. 3I is a screenshot view of a display corresponding to one of the client computing devices in the teleconference session illustrating the transition to the multi-tasking view in which a user interface element displays content relating to the active presenter.

FIG. 3J is a screenshot view of a display corresponding to one of the client computing devices in the teleconference session illustrating a transition to the multi-tasking view which includes the display of calendar content.

FIG. 3K is a screenshot view of a display corresponding to one of the client computing devices in the teleconference session illustrating the transition to the multi-tasking view which includes chat content.

FIGS. 3L, 3M, and 3N are screenshot views of a display corresponding to one of the client computing devices in the teleconference session illustrating a display area for a display of a presenter or content, and a “ME” display area.

FIGS. 3O, 3P, and 3Q are screenshot views of a display corresponding to one of the client computing devices in the teleconference session illustrating the multi-view user interface element positioned at different locations within the window.

FIG. 4 is a flowchart illustrating an operation for presenting a teleconference monitor view with a multi-tasking view on a display of a client computing device as in the example teleconference system of FIG. 1.

### DETAILED DESCRIPTION

Examples described below enable a system to locate and provide monitor views for a teleconference session at a client computing device. The teleconference session may be controlled at a teleconference server connected to a plurality of client computing devices participating in the teleconference session. The client computing devices may be configured to allow a user to multi-task while also staying engaged with the teleconference session. In an example implementation, the teleconference session involves participant streams from client computing devices used by the participants. The participant streams include video, audio, or image data that identify or represent the participants in a display of the teleconference session at the client computing devices. The teleconference session may also receive content streams from one or more client computing devices, or from another source. The content streams include streams that are not participant streams. In some configurations, the content streams include video or image data of files, data structures, word processing documents, formatted documents (e.g. PDF documents), spreadsheets, or presentations to be presented to, and thereby shared with, the participants in the display of the teleconference session. The teleconference session at the server combines the streams to generate teleconference data and transmits the teleconference data to each client computing device according to a teleconference session view configured for each client computing device.

The teleconference session view may be tailored for each client computing device using one of several different views. As discussed briefly above, for a given client computing device, the teleconference session view may be in a first user interface referred to herein as a stage view, or a second user interface referred to herein as a teleconference monitor view. According to some configurations, the stage view provides a total display experience in which either people or content is viewed “on stage,” which is a primary display area of an interface. In some configurations, the primary display area of a user interface can be displayed in a manner that dominates the display on a user's client computing device. The stage view allows a user to be fully immersed with the content being shared among the teleconference participants. User interface elements associated with the stage view can be used to display streams that correspond to participants and the content that is not being displayed on stage and/or otherwise control operations relating to the display of the stage view.

In some implementations, the stage view may be displayed in one of two display modes. A first display mode is a “windowed mode,” which includes a frame around the primary display area, wherein the frame comprises control user interface elements for controlling aspects of the windows, such as minimizing, maximizing, or closing the user interface. The stage view may also be displayed in an “immersive mode,” which does not include a frame. In the immersive mode, the primary display area can occupy the entire display area of a device.

In the stage view, the content or participants are displayed in the primary display area that occupies at least a majority of the display area. The stage view may be changed to a multi-tasking view as a result of the user “multi-tasking” by accessing a category of functionality that is outside of the teleconference session. For example, when the user decides to open a Web browser, the system causes a display of a second user interface, e.g., a multi-tasking view, to display content accessed by the Web browser. The system can also cause a display of a teleconference monitor view within the second user interface to display one or more streams of the teleconference session. In some configurations, the teleconference monitor view is a display of one or more thumbnail sized user interface elements that are configured to display renderings of at least a portion of one or more of the streams. For example, a thumbnail can be configured to display a rendering of the active speaker and/or the content currently being displayed within the teleconference session. In some instances, one or more other thumbnail user interface elements can be configured to display a rendering of a camera view of what the participant is currently providing to the teleconference service, and/or other content associated with the teleconference session.

The teleconference monitor view can be displayed such that the user stays engaged with the teleconference session while also interacting with different categories of functionality outside of the teleconference session. According to some examples, the location of where to render the teleconference monitor view can be based on the selected category of functionality, and in some cases can be based on a graphical analysis of the content associated with the selected category of functionality that is rendered on the display.

User interface elements can be provided to allow the user to switch between different arrangements. In example implementations as described below, the user interface elements allow the user to switch between the stage view and the multi-tasking views. Other views in addition to the stage view and the multi-tasking view may be provided. The user may be provided with tools to switch between the views to alter the user's experience of the teleconference session. For illustrative purposes, the terms “user” and “participant” are used interchangeably and in some scenarios the terms have the same meaning. In some scenarios, a user is associated with and interacting with a computer. A participant, for example, can be a user of a computer viewing and providing input to a teleconference session.

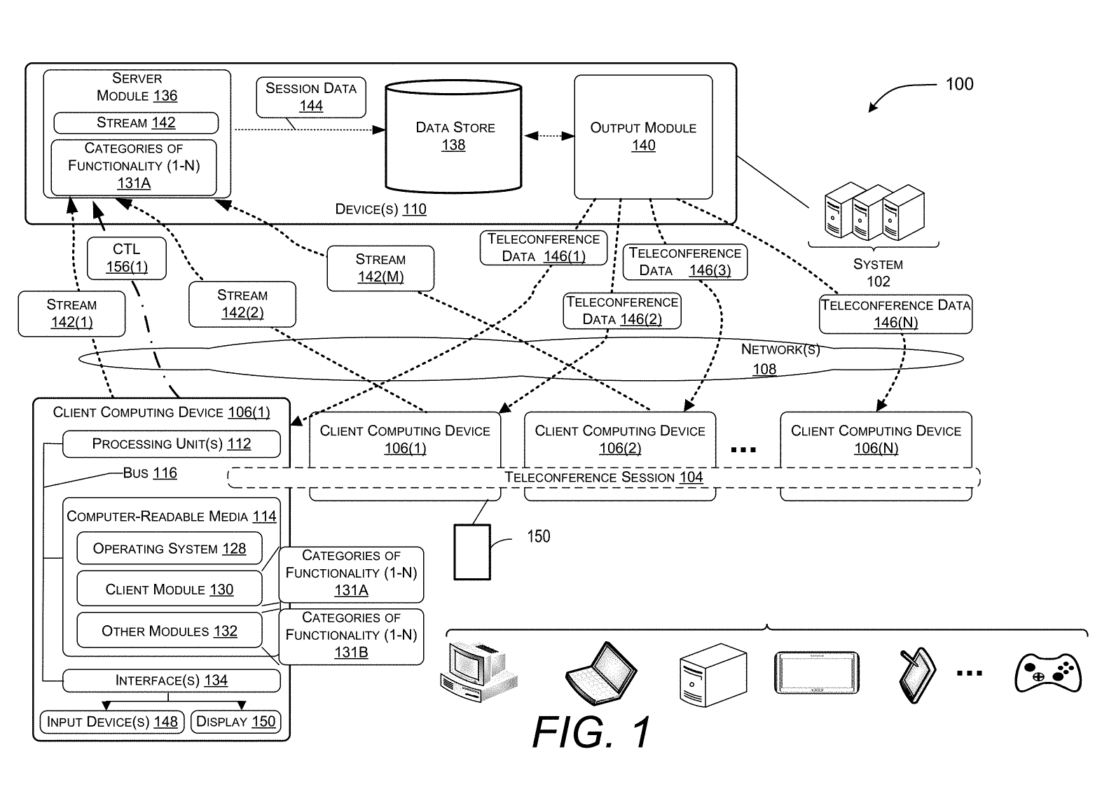

In FIG. 1, a diagram illustrating an example of a teleconference system 100 is shown in which a system 102 can control the display of monitor views for a teleconference session 104 in accordance with an example implementation. In this example, the teleconference session 104 is between a number of client computing devices 106(1) through 106(N) (where N is a positive integer number having a value of two or greater). The client computing devices 106(1) through 106(N) enable users to participate in the teleconference session 104. In this example, the teleconference session 104 may be hosted, over one or more network(s) 108, by the system 102. That is, the system 102 may provide a service that enables users of the client computing devices 106(1) through 106(N) to participate in the teleconference session 104. As an alternative, the teleconference session 104 may be hosted by one of the client computing devices 106(1) through 106(N) utilizing peer-to-peer technologies.

The system 102 includes device(s) 110, and the device(s) 110 and/or other components of the system 102 may include distributed computing resources that communicate with one another, with the system 102, and/or with the client computing devices 106(1) through 106(N) via the one or more network(s) 108. In some examples, the system 102 may be an independent system that is tasked with managing aspects of one or more teleconference sessions 104. As an example, the system 102 may be managed by entities such as SLACK®, WEBEX®, GOTOMEETING®, GOOGLE HANGOUTS®, etc.

Network(s) 108 may include, for example, public networks such as the

Internet, private networks such as an institutional and/or personal intranet, or some combination of private and public networks. Network(s) 108 may also include any type of wired and/or wireless network, including but not limited to local area networks (“LANs”), wide area networks (“WANs”), satellite networks, cable networks, Wi-Fi networks, WiMax networks, mobile communications networks (e.g., 3G, 4G, and so forth) or any combination thereof. Network(s) 108 may utilize communications protocols, including packet-based and/or datagram-based protocols such as Internet protocol (“IP”), transmission control protocol (“TCP”), user datagram protocol (“UDP”), or other types of protocols. Moreover, network(s) 108 may also include a number of devices that facilitate network communications and/or form a hardware basis for the networks, such as switches, routers, gateways, access points, firewalls, base stations, repeaters, backbone devices, and the like.

In some examples, network(s) 108 may further include devices that enable connection to a wireless network, such as a wireless access point (“WAP”). Example networks support connectivity through WAPs that send and receive data over various electromagnetic frequencies (e.g., radio frequencies), including WAPs that support Institute of Electrical and Electronics Engineers (“IEEE”) 802.11 standards (e.g., 802.11g, 802.11n, and so forth), and other standards.

In various examples, device(s) 110 may include one or more computing devices that operate in a cluster or other grouped configuration to share resources, balance load, increase performance, provide fail-over support or redundancy, or for other purposes. For instance, device(s) 110 may belong to a variety of classes of devices such as traditional server-type devices, desktop computer-type devices, and/or mobile-type devices. Thus, although illustrated as a single type of device—a server-type device—device(s) 110 may include a diverse variety of device types and are not limited to a particular type of device. Device(s) 110 may represent, but are not limited to, server computers, desktop computers, web-server computers, personal computers, mobile computers, laptop computers, mobile phones, tablet computers, or any other sort of computing device.

A client computing device (e.g., one of client computing device(s) 106(1) through 106(N)) may belong to a variety of classes of devices, which may be the same as, or different from, device(s) 110, such as traditional client-type devices, desktop computer-type devices, mobile-type devices, special purpose-type devices, embedded-type devices, and/or wearable-type devices. Thus, a client computing device can include, but is not limited to, a desktop computer, a game console and/or a gaming device, a tablet computer, a personal data assistant (“PDA”), a mobile phone/tablet hybrid, a laptop computer, a teleconference device, a computer navigation type client computing device such as a satellite-based navigation system including a global positioning system (“GPS”) device, a wearable device, a virtual reality (“VR”) device, an augmented reality (AR) device, an implanted computing device, an automotive computer, a network-enabled television, a thin client, a terminal, an Internet of Things (“IoT”) device, a work station, a media player, a personal video recorder (“PVR”), a set-top box, a camera, an integrated component (e.g., a peripheral device) for inclusion in a computing device, an appliance, or any other sort of computing device. In some implementations, a client computing device includes input/output (“I/O”) interfaces that enable communications with input/output devices such as user input devices including peripheral input devices (e.g., a game controller, a keyboard, a mouse, a pen, a voice input device, a touch input device, a gestural input device, and the like) and/or output devices including peripheral output devices (e.g., a display, a printer, audio speakers, a haptic output device, and the like).

Client computing device(s) 106(1) through 106(N) of the various classes and device types can represent any type of computing device having one or more processing unit(s) 112 operably connected to computer-readable media 114 such as via a bus 116, which in some instances can include one or more of a system bus, a data bus, an address bus, a PCI bus, a Mini-PCI bus, and any variety of local, peripheral, and/or independent buses. The computer-readable media 114 may store executable instructions and data used by programmed functions during operation. Examples of functions implemented by executable instructions stored on the computer-readable media 114 may include, for example, an operating system 128, a client module 130, other modules 132, and, programs or applications that are loadable and executable by processing units(s) 112.

Client computing device(s) 106(1) through 106(N) may also include one or more interface(s) 134 to enable communications with other input devices 148 such as network interfaces, cameras, keyboards, touch screens, and pointing devices (mouse). For example, the interface(s) 134 enable communications between client computing device(s) 106(1) through 106(N) and other networked devices, such as device(s) 110 and/or devices of the system 102, over network(s) 108. Such network interface(s) 134 may include one or more network interface controllers (NICs) or other types of transceiver devices to send and receive communications and/or data over a network.

In the example environment 100 of FIG. 1, client computing devices 106(1) through 106(N) may use their respective client modules 130 to connect with one another and/or other external device(s) in order to participate in the teleconference session 104. For instance, a first user may utilize a client computing device 106(1) to communicate with a second user of another client computing device 106(2). When executing client modules 130, the users may share data, which may cause the client computing device 106(1) to connect to the system 102 with the other client computing devices 106(2) through 106(N) over the network 108.

The client module 130 of each client computing device 106(1) through 106(N) may include logic that detects user input and communicates control signals to the server to request a first category of functionality relating to controlling aspects of the teleconference session 104, as well as requesting the server to request one or more other categories of functionality that can be provided by the system 102. For example, the client module 130 in the first client computing device 106(1) in FIG. 1 may detect a user input at an input device 148. The user input may be sensed, for example, as a finger press on a user interface element displayed on a touchscreen, or as a click of a mouse on a user interface element selected by a pointer on the display 150. The client module 130 translates the user input according to a function associated with the selected user interface element. The client module 130 may send a control signal 156(1) (also referred to herein as a “control command” or an “indication”) to a server (for example, a server operating on the device 110) to perform the desired function. In some examples, the client module 130 may send a control signal to a server indicating that the user has selected to perform a task using a different program, such as provided by one of the other modules 132.

In one example function, the user of the client computing device 106(1) may wish to multi-task during the teleconference session 104. For instance, a user may desire to interact with a second category of functionality that is not part of the first category of functionality that is associated with a display of the stage view of teleconference session 104 (e.g., accessing a web browser, a productivity application, a photo application, an entertainment application, and the like). As an example, the user may interact with functionality provided by the other modules 132 and/or interact with functionality provided by a different service during the teleconference session 104. Using techniques described herein, the user of the client computing device 106(1) can continue to stay engaged with people and content of the teleconference session 104 while multi-tasking inside and outside of the teleconference application.

As illustrated, the client module 130 can be associated with categories of functionality 131A and the other modules can be associated with categories of functionality 131B. The client module can be used to access one or more categories that are provided by the teleconference system 102 via the server module 136. In some configurations, the client module 130 can be configured to provide one or more of the categories of functionality 131A.

As discussed above, the teleconference service may provide users with many different tools that are associated with different categories of functionality 131A. For example, the teleconference service may provide a first category of functionality that is associated with managing a teleconference session, a second category of functionality that is associated with electronic messaging, a third category of functionality that is associated with document viewing and/or editing, a fourth category of functionality that is associated with managing a calendar, a fifth category of functionality that is associated with a chat service, and the like.

During a teleconference session 104, the user can also access the different categories of functionality 131B that are associated with other applications and/or services. For example, a user might access a category of functionality that is associated with a Web browser, an email application, a mapping service, a music application, a video application, and the like. Generally, the other modules 132 can be any type of application or service accessible by the client computing device 106(1).

Enabling users of a teleconference session to access different categories of functionality (e.g., tools for selecting, viewing, and modifying various forms of content) while simultaneously viewing one or more streams of the teleconference session keeps the them engaged in the session while enabling multi-tasking.

In some examples, when the user is navigating other functionality provided by the teleconference system or accessing other functionality provided by a different application, at least a portion of the one or more streams can be rendered within a teleconference monitor view that is displayed within or concurrently with a multi-tasking view. For example, the teleconference monitor view can be displayed within a user interface element that is associated with the other category of functionality. In one illustrative example, the teleconference monitor view rendering a video stream of a participant can be displayed within a display area rendering chat messages when the user is accessing the category of functionality associated with the chat program.

According to some examples, the location of where to render the teleconference monitor view can be based on a selected category of functionality. In some configurations, the server module 136 of the teleconference service can position the teleconference monitor view on the display 150 based on knowledge of the locations of the displayed user interface elements and content within the user interfaces associated with the selected category of functionality. For example, when the user selects chat functionality that is provided by the category of functionality 131A, the teleconference monitor view may be placed within an area of the menu bar that does not include other content. Similarly, when the user selects contact functionality such as an address book that is provided by the category of functionality 131A, the teleconference monitor view can be placed in a predetermined position that does not obscure the address information, phone controls, and the like. In some configurations, a default location can be associated with each of the different categories of functionality.

In other examples, the location of the teleconference monitor view can be based on an analysis of the content that is displayed as a result of the user selecting the category of functionality. According to some techniques, the teleconference system performs an analysis of graphical data rendered on the display 150 to identify areas on the display that do not include selectable user interface elements (e.g., control buttons, selectors, scroll bars, and the like) or are areas of the display that do not include other types of content that the user may want to view (e.g., text, drawings, graphs). For instance, when the user selects functionality from the categories of functionality 131B, the server module 136 can obtain a screenshot of the display 150 and perform an edge detection mechanism, a histogram, or some other technique to identify areas on the display 150 that include selectable user interface elements as well as identify areas on the display that include other graphical content. When there is an area identified to not include user interface controls and/or other content, the server module 136, and or the client module 130, or some other component, can determine the location on the display at which to render the teleconference monitor view.

As discussed above, the teleconference session views can include a stage view that includes a display area for participants and content. In some examples, the stage view is displayed when the user is not multi-tasking. When the user decides to multi-task, and causes a different user interface element to be displayed (e.g., accessing another application or accessing functionality provided by the teleconference system 102 that causes the stage view to be removed from the display and/or hidden from view (or at least partially obscured).

Instead of the user not being able to view content or people associated with the teleconference session 104 when the user navigates away from the stage view by selecting a different category of functionality, the teleconference system 102 presents the multi-tasking view with a teleconference monitor view (e.g., a thumbnail user interface element) that provides a rendering of at least one teleconference stream. For example, the teleconference monitor view can display the current presenter, and/or other content. In some instances, the teleconference monitor view includes a thumbnail view of the current presenter and/or content being presented. According to some configurations, a portion of the teleconference monitor view displays a video stream of the user's camera view when the user is sharing a camera view. In some implementations, the multi-tasking display area can individually be configured as a region comprising selectable user interface elements for selecting streams associated with the individual display areas. The size and position of the teleconference monitor view can be set based on predetermined settings, user preferences, and/or user positioning.

The stage view and the teleconference monitor view can also include graphical elements providing control functionality (“control elements”) for a teleconference session. For instance, a graphical element may be generated on the user interface enabling a user to provide content, end a session, mute one or more sounds, return to the stage view, and the like.

In response to the user navigating away from the stage view on the display 150 that provides a more immersive teleconference experience for the user, the system 102 detects the change (e.g., via the CTL 156(1) signal) and causes the teleconference monitor view to be presented on the display 150. According to some techniques, the client module 130 may identify the selection of a user interface element as a request to exit the stage view, but not exit the program. In response to detecting the request, the client module 130 sends a control signal 156(1) to a teleconference session host to perform the view switching function that causes the teleconference monitor view to be presented along with the multi-tasking view within the display 150. In other examples, the client module 130, or some other component or module, provides an indication to the teleconference host that the user has changed views and is accessing a different category of functionality. Upon receiving the indication to switch views, the server module 136 can determine the location on the display 150 where to render the teleconference monitor view, generate the teleconference stream associated with the teleconference monitor view, and cause the teleconference stream to be rendered on the display 150.

The client computing device(s) 106(1)-106(N) may use their respective client modules 132, or some other module (not shown) to generate participant profiles, and provide the participant profiles to other client computing devices and/or to the device(s) 110 of the system 102. A participant profile may include one or more of an identity of a participant (e.g., a name, a unique identifier (“ID”), etc.), participant data, such as personal data and location data which may be stored. Participant profiles may be utilized to register participants for teleconference sessions.

As shown in FIG. 1, the device(s) 110 of the system 102 includes a server module 136, a data store 138, and an output module 140. The server module 136 is configured to receive, from individual client computing devices 106(1) through 106(N), streams 142(1) through 142(M) (where M is a positive integer number equal to 2 or greater). In some scenarios, not all the client computing devices utilized to participate in the teleconference session 104 provide an instance of streams 142, and thus, M (the number of instances submitted) may not be equal to N (the number of client computing devices). In some other scenarios, one or more of the client computing devices may be communicating an additional stream that includes content, such as a document or other similar type of media intended to be shared during the teleconference session.

The server module 136 is also configured to receive, generate and communicate session data 144 and to store the session data 144 in the data store 138. The session data 144 can define aspects of a teleconference session 104, such as the identities of the participants, the content that is shared, etc. In various examples, the server module 136 may select aspects of the streams 142 that are to be shared with the client computing devices 106(1) through 106(N). The server module 136 may combine the streams 142 to generate teleconference data 146 defining aspects of the teleconference session 104. The teleconference data 146 can comprise individual streams containing select streams 142. The teleconference data 146 can define aspects of the teleconference session 104, such as a user interface arrangement of the user interfaces on the client computing devices, the type of data that is displayed and other functions of the server and client computing devices. The server module 136 may configure the teleconference data 146 for the individual client computing devices 106(1)-106(N). Teleconference data can be divided into individual instances referenced as 146(1)-146(N). The output module 140 may communicate the teleconference data instances 146(1)-146(N) to the client computing devices 106(1) through 106(N). Specifically, in this example, the output module 140 communicates teleconference data instance 146(1) to client computing device 106(1), teleconference data instance 146(2) to client computing device 106(2), teleconference data instance 146(3) to client computing device 106(3), and teleconference data instance 146(N) to client computing device 106(N), respectively.

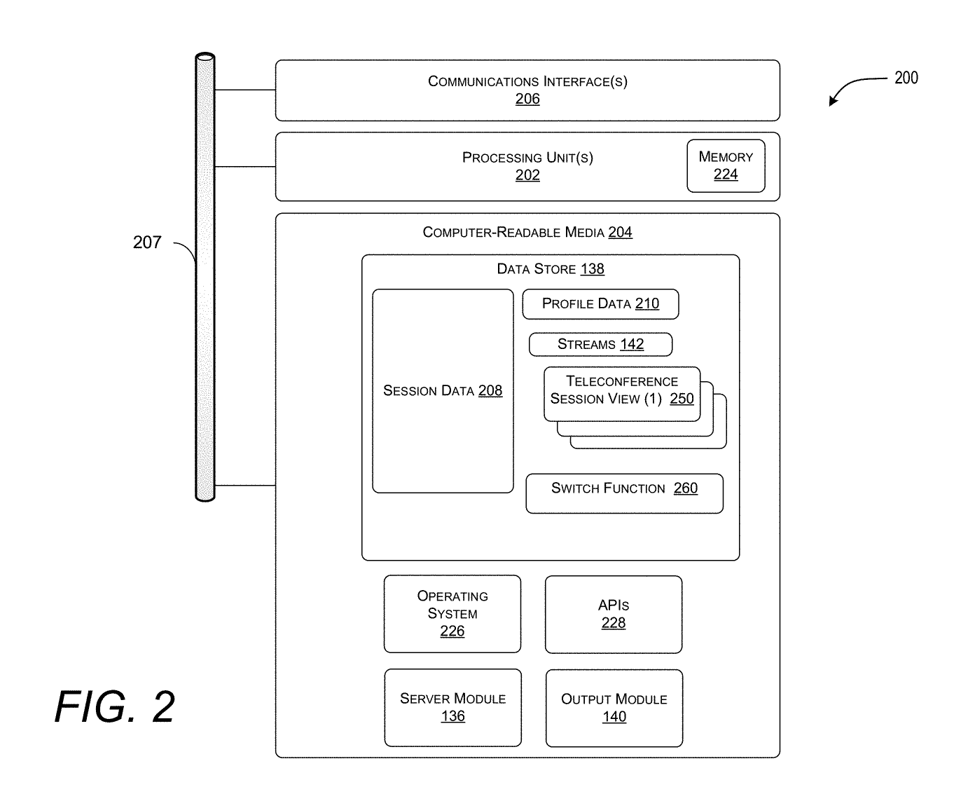

The teleconference data instances 146(1)-146(N) may communicate audio that may include video representative of the contribution of each participant in the teleconference session 104. Each teleconference data instance 146(1)-146(N) may also be configured in a manner that is unique to the needs of each participant user of the client computing devices 106(1) through 106(N). Each client computing device 106(1)-106(N) may be associated with a teleconference session view. Examples of the use of teleconference session views to control the views for each user at the client computing devices are described with reference to FIG. 2.

In FIG. 2, a system block diagram is shown illustrating components of an example device 200 configured to provide the teleconference session 104 between the client computing devices, such as client computing devices 106(1)-106(N) in accordance with an example implementation. The device 200 may represent one of device(s) 110 where the device 200 includes one or more processing unit(s) 202, computer-readable media 204, communication interface(s) 206. The components of the device 200 are operatively connected, for example, via a bus 207, which may include one or more of a system bus, a data bus, an address bus, a PCI bus, a Mini-PCI bus, and any variety of local, peripheral, and/or independent buses.

As utilized herein, processing unit(s), such as the processing unit(s) 202 and/or processing unit(s) 112, may represent, for example, a CPU-type processing unit, a GPU-type processing unit, a field-programmable gate array (“FPGA”), another class of digital signal processor (“DSP”), or other hardware logic components that may, in some instances, be driven by a CPU. For example, and without limitation, illustrative types of hardware logic components that may be utilized include Application-Specific Integrated Circuits (“ASICs”), Application-Specific Standard Products (“ASSPs”), System-on-a-Chip Systems (“SOCs”), Complex Programmable Logic Devices (“CPLDs”), etc.

As utilized herein, computer-readable media, such as computer-readable media 204 and/or computer-readable media 114, may store instructions executable by the processing unit(s). The computer-readable media may also store instructions executable by external processing units such as by an external CPU, an external GPU, and/or executable by an external accelerator, such as an FPGA type accelerator, a DSP type accelerator, or any other internal or external accelerator. In various examples, at least one CPU, GPU, and/or accelerator is incorporated in a computing device, while in some examples one or more of a CPU, GPU, and/or accelerator is external to a computing device.

Computer-readable media may include computer storage media and/or communication media. Computer storage media may include one or more of volatile memory, nonvolatile memory, and/or other persistent and/or auxiliary computer storage media, removable and non-removable computer storage media implemented in any method or technology for storage of information such as computer-readable instructions, data structures, program modules, or other data. Thus, computer storage media includes tangible and/or physical forms of media included in a device and/or hardware component that is part of a device or external to a device, including but not limited to random-access memory (“RAM”), static random-access memory (“SRAM”), dynamic random-access memory (“DRAM”), phase change memory (“PCM”), read-only memory (“ROM”), erasable programmable read-only memory (“EPROM”), electrically erasable programmable read-only memory (“EEPROM”), flash memory, compact disc read-only memory (“CD-ROM”), digital versatile disks (“DVDs”), optical cards or other optical storage media, magnetic cassettes, magnetic tape, magnetic disk storage, magnetic cards or other magnetic storage devices or media, solid-state memory devices, storage arrays, network attached storage, storage area networks, hosted computer storage or any other storage memory, storage device, and/or storage medium that can be used to store and maintain information for access by a computing device.

In contrast to computer storage media, communication media may embody computer-readable instructions, data structures, program modules, or other data in a modulated data signal, such as a carrier wave, or other transmission mechanism. As defined herein, computer storage media does not include communications media. That is, computer storage media does not include communications media consisting solely of a modulated data signal, a carrier wave, or a propagated signal, per se.

Communication interface(s) 206 may represent, for example, network interface controllers (“NICs”) or other types of transceiver devices to send and receive communications over a network. The communication interfaces 206 are used to communication over a data network with client computing devices 106.

In the illustrated example, computer-readable media 204 includes the data store 138. In some examples, the data store 138 includes data storage such as a database, data warehouse, or other type of structured or unstructured data storage. In some examples, the data store 138 includes a corpus and/or a relational database with one or more tables, indices, stored procedures, and so forth to enable data access including one or more of hypertext markup language (“HTML”) tables, resource description framework (“RDF”) tables, web ontology language (“OWL”) tables, and/or extensible markup language (“XML”) tables, for example.

The data store 138 may store data for the operations of processes, applications, components, and/or modules stored in computer-readable media 204 and/or executed by processing unit(s) 202 and/or accelerator(s). For instance, in some examples, the data store 138 may store session data 208 (e.g., session data 144), profile data 210, and/or other data. The session data 208 may include a total number of participants in the teleconference session 104, and activity that occurs in the teleconference session 104 (e.g., behavior, activity of the participants), and/or other data related to when and how the teleconference session 104 is conducted or hosted. Examples of profile data 210 include, but are not limited to, a participant identity (“ID”) and other data.

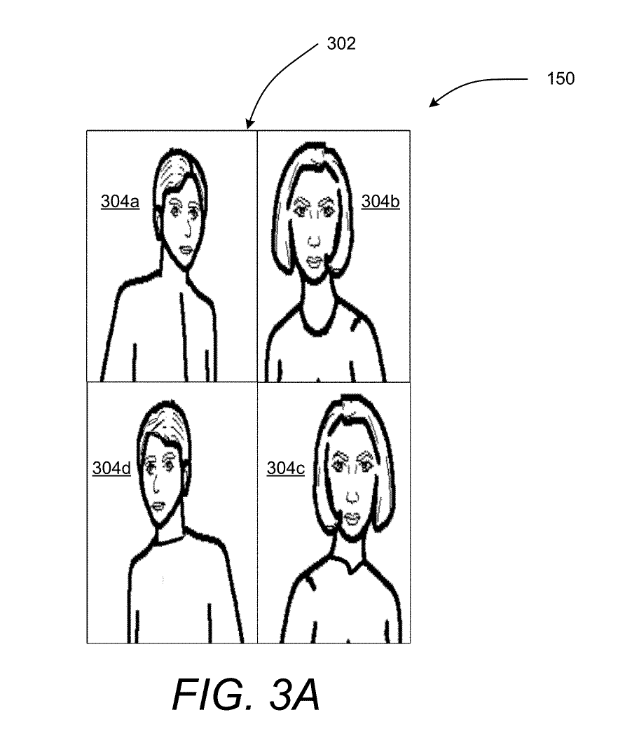

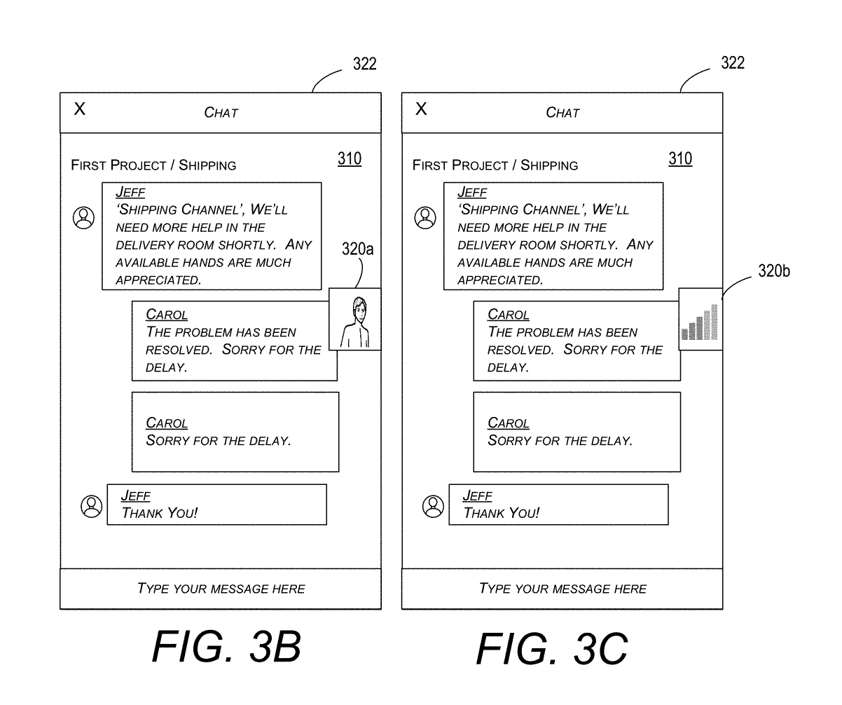

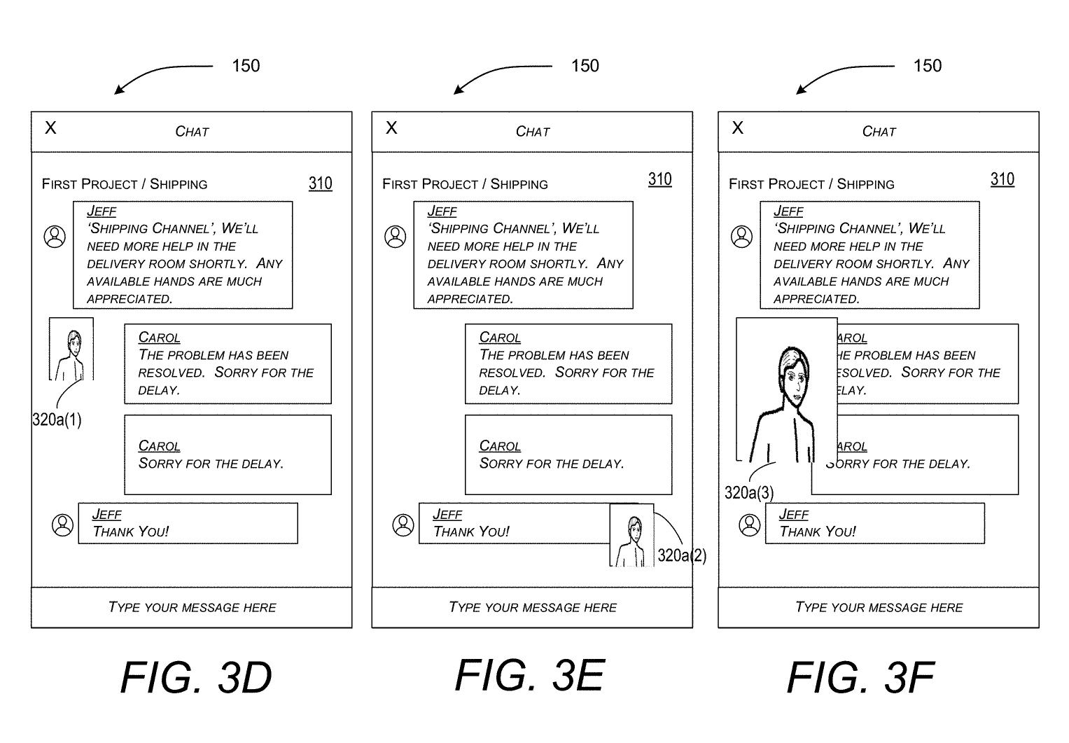

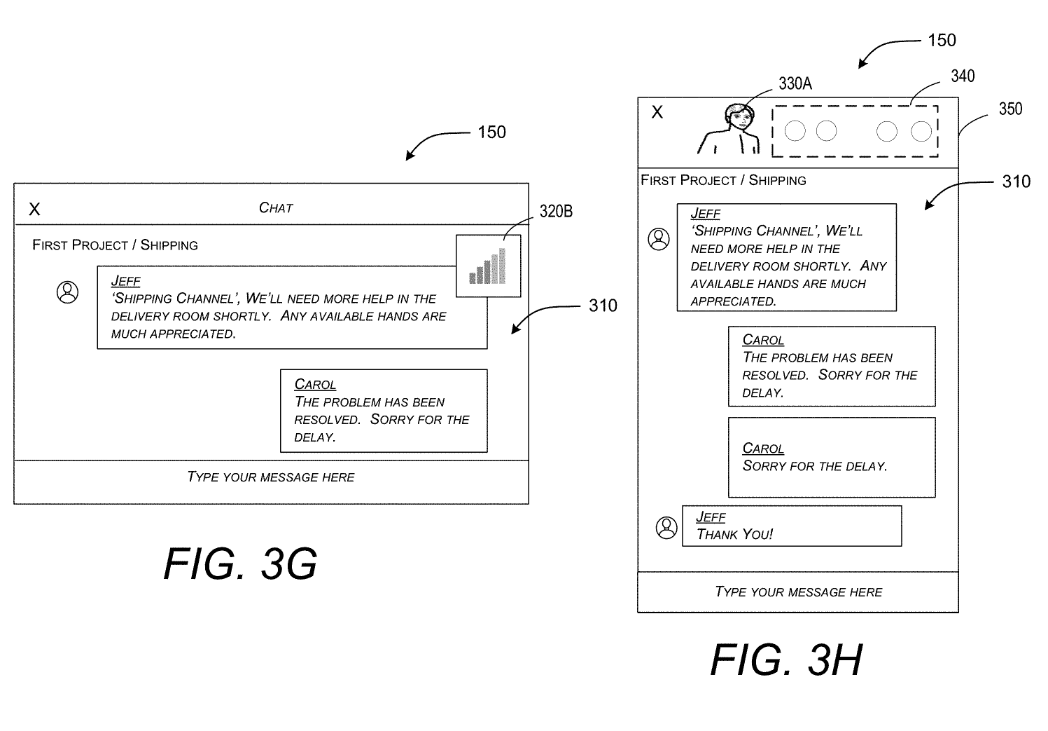

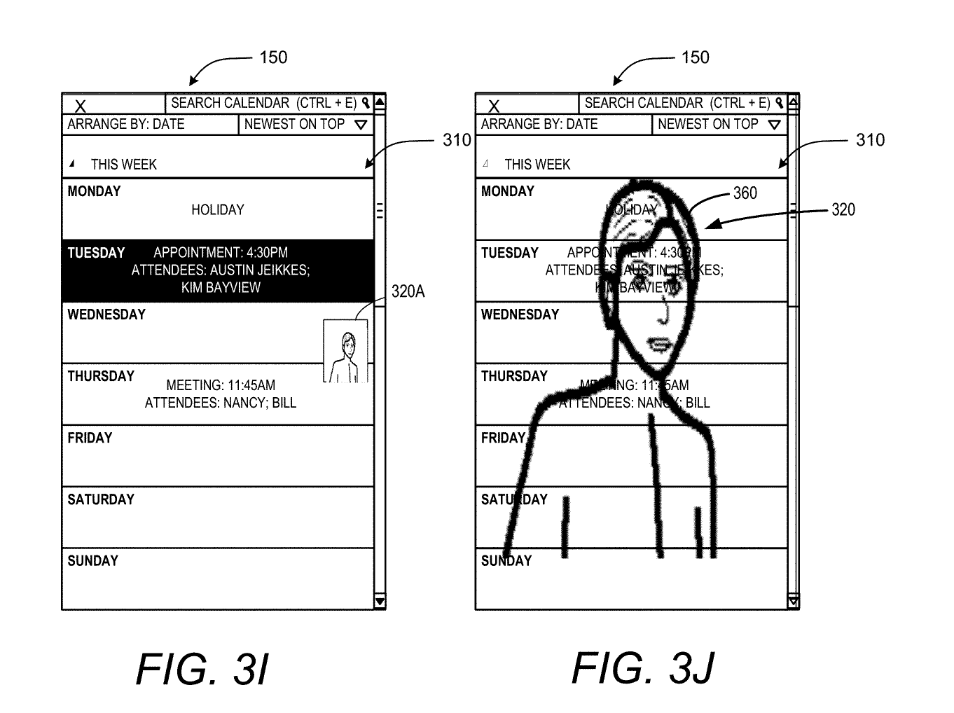

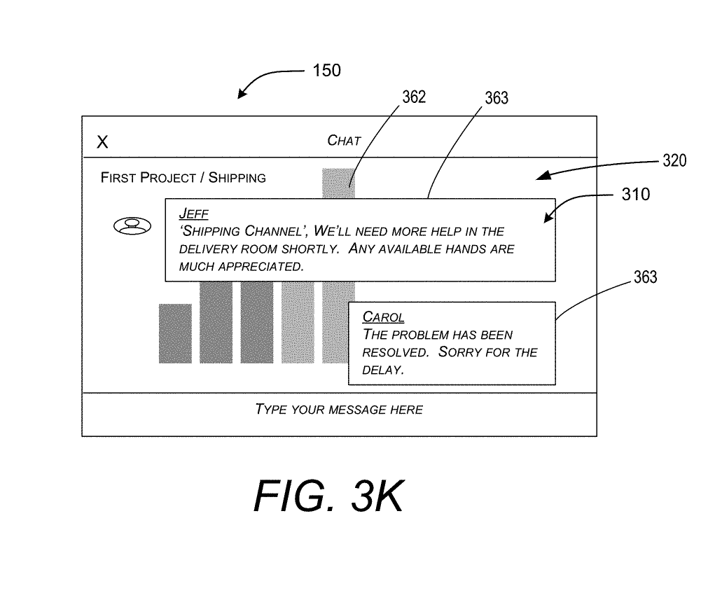

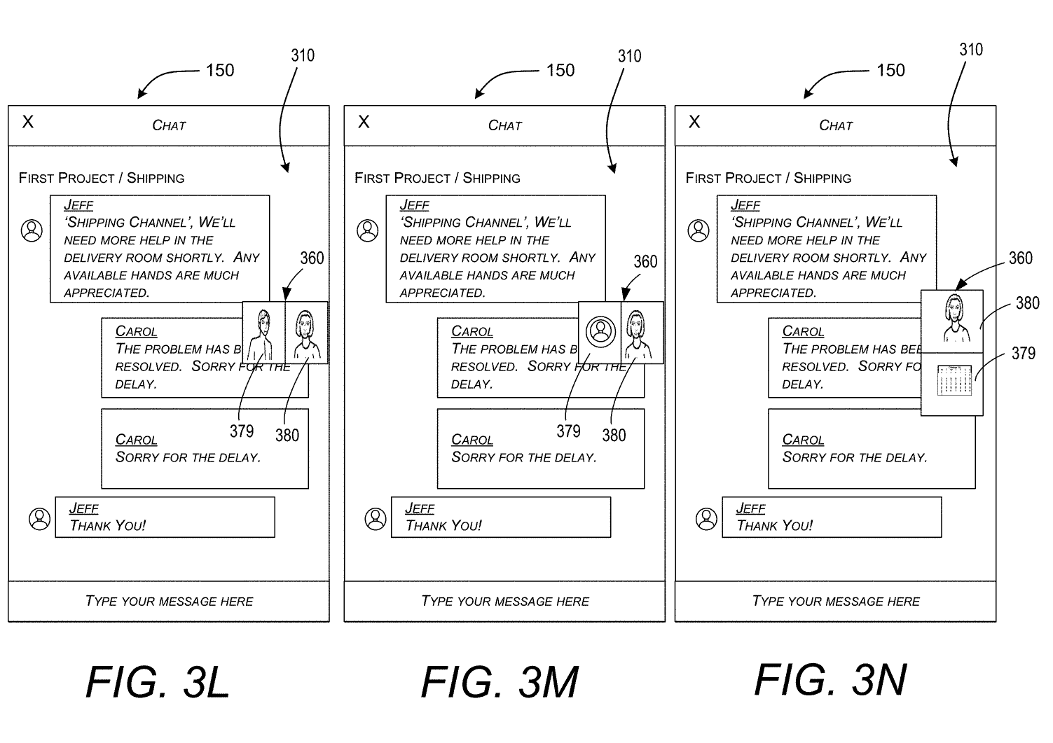

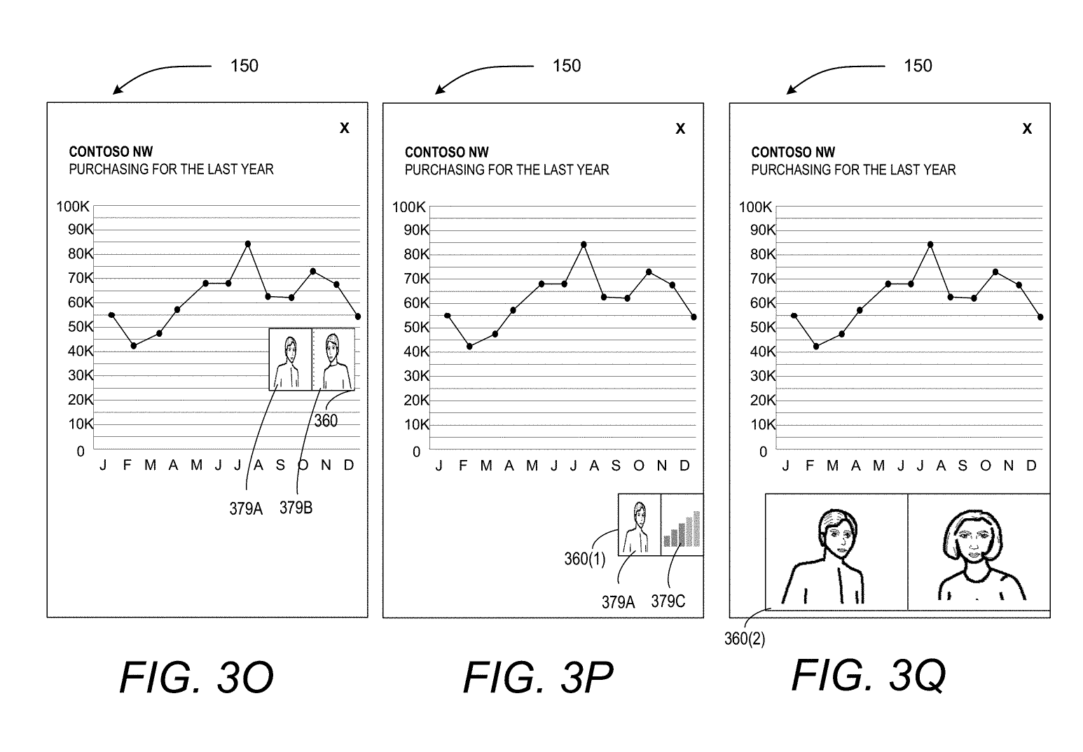

In an example implementation, the data store 138 stores data related to the view each participant experiences on the display of the users' client computing devices 106. As shown in FIG. 2, the data store 138 may include a teleconference session view 250(1) through 250(N) corresponding to the display of each client computing device 106(1) through 106(N) participating in the teleconference session 104. In this manner, the system 102 may support individual control over the view each user experiences during the teleconference session 104. For example, as described in more detail below with reference to FIGS. 3A-3Q the system 102 displays a stage view when the user is not accessing other functionality and displays a teleconference monitor view when the user is multi-tasking by accessing other functionality. In some examples, the teleconference monitor view can be an overlay view. Overlay views feature the display of desired media that cover a portion of a display area. Controls, user interface elements such as icons, buttons, menus, etc., and other elements not directly relevant to the presentation provided by the teleconference session on the display simply do not appear.

The view on a user's display may be changed to keep the user engaged in the teleconference session even though the user is multi-tasking. For example, as the user is viewing other content associated with a selected category or functionality associated with content that is not part of the teleconference session, the system 102 can select a size and/or location of a rendering of a stream associated with the teleconference session that optimizes the display of the content associated with a selected category or functionality. Such embodiments enable a user to close a user interface of a teleconference session, and open another user interfaces, e.g., a Word Processor interface for viewing a document, a Calendar Program interface to edit a calendar, or another interface controlled by functionality to view other content, while automatically determining a size and location of the display of the stream of the teleconference session within each interface.

The teleconference session view 250(1)-250(N) may store data identifying the view being displayed for each client computing device 106(1)-106(N). The teleconference session view 250 may also store data relating to streams configured for display, the participants associated with the streams, whether content media is part of the display, and information relating to the content. Some teleconference sessions may involve a large number of participants. However, only a core number of the participants may be what can be referred to as “active participants.” The teleconference session view for each user may be configured to focus on media provided by the most active participants. Some teleconference sessions may involve a presenter entity, such as in a seminar, or a presentation by one or more individual presenters. At any given time, one participant may be a presenter, and the presenter may occupy an enhanced role in a teleconference session. The presenter's role may be enhanced by maintaining a consistent presence on the user's display. Information relating to the presenter may be maintained in the teleconference session view 250.

As noted above, the data store 138 may store the profile data 210, streams 142, teleconference session views 250, session data 208, and switch function 260. Alternately, some or all of the above-referenced data can be stored on separate memories 224 on board one or more processing unit(s) 202 such as a memory on board a CPU-type processor, a GPU-type processor, an FPGA-type accelerator, a DSP-type accelerator, and/or another accelerator. In this example, the computer-readable media 204 also includes an operating system 226 and an application programming interface(s) 228 configured to expose the functionality and the data of the device(s) 110 (e.g., example device 200) to external devices associated with the client computing devices 106(1) through 106(N). Additionally, the computer-readable media 204 includes one or more modules such as the server module 136 and an output module 140, although the number of illustrated modules is just an example, and the number may vary higher or lower. That is, functionality described herein in association with the illustrated modules may be performed by a fewer number of modules or a larger number of modules on one device or spread across multiple devices.

As such and as described earlier, in general, the system 102 is configured to host the teleconference session 104 with the plurality of client computing devices 106(1) through 106(N). The system 102 includes one or more processing units 202 and a computer-readable medium 204 having encoded thereon computer-executable instructions to cause the one or more processing units 202 to receive streams 142(1)-142(M) at the system 102 from a plurality of client computing devices 106(1)-106(N), select streams 142 based, at least in part, on the teleconference session view 250 for each user, and communicate teleconference data 146 defining the teleconference session views 250 corresponding to the client computing devices 106(1) through 106(N). The teleconference data instances 146(1)-146(N) are communicated from the system 102 to the plurality of client computing devices 106(1) through 106(N). The teleconference session views 250(1)-250(N) cause the plurality of client computing devices 106(1)-106(N) to display views of the teleconference session 104 under user control. The computer-executable instructions also cause the one or more processing units 202 to determine that the teleconference session 104 is to transition to a different teleconference session view of the teleconference session 104 based on a user communicated view switch control signal 156.

As discussed, the techniques disclosed herein may utilize one or more “views.” In some examples, the views include the stage view (also referred to herein as “teleconference session views”) and the teleconference monitor view. In an example of an operation, the system 102 performs a method that includes receiving the streams 142(1)-142(N) at the system 102 from a plurality of client computing devices 106(1)-106(N). The system combines and formats the streams 142 based, at least in part, on a selected teleconference session view for each client computing device to generate teleconference data 146, e.g., teleconference data instances 146(1)-146(N). The teleconference data instances 146(1)-146(N) are then communicated to the individual client computing devices 106(1)-106(N).

It is noted that the above description of the hosting of a teleconference session 104 by the system 102 implements the control of the teleconference session view in a server function of the device 110. In some implementations, the server function of the device 110 may combine all media portions into the teleconference data for each client computing device 106 to configure the view to display. The information stored in the teleconference session view as described above may also be stored in a data store of the client computing device. The client computing device may receive a user input and translate the user input as being a view switching control signal that is not transmitted to the server. The view switching control signal may be processed on the client computing device itself to cause the display to switch to the desired view. The client computing device 106 may change the display by re-organizing the portions of the teleconference data 146 received from the server according to the view selected by the user.

The ability for users to switch between a stage view (a teleconference session view) and the multi-tasking view is described with reference to screenshots of the display. Specifically, reference is made to FIG. 3A, which illustrates an example display of a stage view. Also, reference is made to FIGS. 3B-3Q which illustrate example displays of multi-tasking views that each include a concurrently displayed teleconference monitor view. In some configurations, the teleconference monitor view is not displayed unless the view transitions from the stage view to a multi-tasking view. The displayed multi-tasking view can show content generated by a selected category of functionality associated with the multi-tasking view, such as calendar functionality, a chat functionality, etc. The system can transition to the selected category of functionality from an originating category of functionality controlling aspects of the stage view and the teleconference session 104.

FIG. 3A depicts an example of a display 150, which is shown connected to interface 134 of client computing device 106(1) in FIG. 1, displaying a stage view of the teleconference session 104 in accordance with an example implementation. The stage view can, in some configurations, extend substantially across the screen area 302 of the display 150. In some configurations, the display area 302 is configured in a manner that dominates the display. In some configurations, the display area 302 can be substantially from edge-to-edge.

As illustrated, the display area 302 is divided into four graphic elements 304a-304d each corresponding to streams of a teleconference session 104. The streams can include audio, audio and video, or audio and an image communicated from a client computing device belonging to a user participating in the teleconference session 104.

Four graphic elements 304a-304d are shown occupying the display area 302 in the example shown in FIG. 3A; however, any number of graphic elements may be displayed. In some examples, the number of displayed graphic elements may be limited to a maximum by available bandwidth or by a desire to limit video clutter on the display 150. Fewer than four graphic elements 304a-304d may be displayed when fewer than four participants are involved in the teleconference session. In teleconference sessions involving more than the maximum number of graphic elements, the graphic elements 304a-304d displayed may correspond to the dominant participants or those deemed to be “active participants.” The designation of “active participants” may be defined as a reference to specific presenters, or as in some implementations, a function may be provided to identify “active participants” versus passive participants by applying a teleconference session activity level priority. The streams can also include renderings of content and groups of participants.

The activity level priority ranks participants based on their likely contribution to the teleconference. In an example implementation, an activity level priority for identifying active versus passive participants may be determined at the server 136 by analyzing streams associated with individual participants. The teleconference system may include a function that compares the activity of participants and dynamically promotes those who speak more frequently or those that move and/or speak more frequently to be the active participants.

The order of the graphic elements 304a-304d may also reflect the activity level priority of the participants to which the graphic elements correspond. For example, a stage view may be defined as having a convention in which the top left corner of the primary display area 302 displays the graphic element 304a corresponding to the most dominant participant. In some sessions, the dominant participant may be a presenter. The top right corner of the primary display area 302 may display the graphic element 304b corresponding to the second ranked participant. The lower right hand corner of the primary display area 302 may display the graphic element 304c corresponding to the third ranked participant. The lower left hand corner of the primary display area 302 may display the graphic element 304d corresponding to the lowest ranked participant. In some sessions, the top right corner may display the graphic element 304a corresponding to a presenter, and the other three positions on the primary display area 302 may dynamically switch to more active participants at various times during the session.

In an example implementation, the transition to the multi-tasking view may be triggered when the user begins to multi-task by selecting functionality outside of the category of functionality associated with providing the stage view. As discussed above, the client computing device 106 detects the input, and in response to the input, the device 106 may responsively transmit a state change indicator, e.g., a control command, to the server to modify the view from the stage view (FIG. 3A) to a multi-tasking view (FIG. 3B-3Q).

FIG. 3B depicts the transition to a multi-tasking view 310 that is associated with “chat” functionality. The multi-tasking view 310 also comprises a teleconference monitor view 320a that renders a stream of a teleconference session 104, e.g., content relating to an active presenter. In the current example, the user has selected “chat” functionality that is provided by the teleconference system 102. In response to selection of the chat functionality being selected, the chat view 322 is displayed along with the teleconference monitor view 320a.

The teleconference monitor view 320a can include an image, an avatar, or a video of the active speaker or presenter of the teleconference session. The teleconference monitor view 320a can be displayed within a user interface element as a miniaturized video or image screen having any suitable aspect ratio such as for example, 16:9, 4:3, 3:2, 5:4, 5:3, 8:5, 1.85:1, 2.35:1, or any aspect ratio deemed suitable in specific implementations. The miniaturized screen may be playing video or display a static image. For example, the presenter may be represented by an icon or avatar.

In the current example, the teleconference monitor view 320a is positioned according to a default position for a category of functionality associated with chat functionality that might be provided by the teleconference system 102 and/or some other application or service. Although this example shows a default position that is on the middle-right position, the default location can be in any other suitable location. In some configurations, the default location can be in a location that minimizes visual conflicts, e.g., a position that covers important information, with the content of a particular multi-tasking view.

FIG. 3C depicts a transition to the multi-tasking view 310 that is associated with “chat” functionality. In this example, the teleconference monitor view 320b displays content relating to the content currently being presented within the teleconference session 104. In this example, in response to selection of the chat functionality being selected, the chat view 322 is displayed along with the teleconference monitor view 320b.

The teleconference monitor view 320b can include an image, or a video of the content being shown in the teleconference session. In some examples, the content displayed within the teleconference monitor view 320b can be selected based on a current selected area of a document. The teleconference monitor view 320b can be displayed as a miniaturized video or image screen having any suitable aspect ratio such as for example, 16:9, 4:3, 3:2, 5:4, 5:3, 8:5, 1.85:1, 2.35:1, or any aspect ratio deemed suitable in specific implementations. The miniaturized screen may be playing video or display a static image. In the current example, the teleconference monitor view 320b is positioned according to a default position for a category of functionality associated with chat functionality that might be provided by the teleconference system 102 and/or some other application or service.

FIGS. 3D, 3E, and 3F depict the teleconference monitor view 320 within different positions of the display 150 and/or a different size. FIG. 3D depicts the teleconference monitor view 320a(1) located near the middle left portion of the display 150. FIG. 3E depicts the teleconference monitor view(2) located near the bottom right portion of the display 150. FIG. 3F depicts a resized teleconference monitor view(3) located near the middle left portion of the display 150.

Generally, the position and/or size of the user interface element or a graphical user interface associated with, e.g., containing, the teleconference monitor view can be changed. In some examples, the position and/or size are based on user preferences. In other examples, the position and/or size is based on the content currently being displayed. For instance, in the current example depicted in FIG. 3D, the system 102, or some other component can analyze the display area 150 to determine a location and size for the user interface element associated with the teleconference monitor view. According to some configurations, the system 102 identifies locations of the display that do not include selectable user interface elements such that the teleconference monitor view 320a is not placed over a portion of the display 150 that the user may desire to interact with. As discussed above, in some examples, the location of where to position the teleconference monitor view 320 is based on the category of functionality being used by the user by multi-tasking.

In some configuration, the system can identify areas of a graphical user interface having less than a threshold level of priority. For instance, if a display of a web page or a document has text, the system may select an area having the least amount of text or no text. In displays having images, the system may select an area having the least amount of image data or no image data. In some configurations, the system may analyze the text and determine if the text has a meaning having a priority. The system can then select the location based on areas of the graphical user interface having less than a threshold level of priority. For example, the location can be at a position in a document where there no text or images, or having low priority text or images.

FIG. 3G depicts the transition to the multi-tasking view 310 displaying content in a landscape mode. The display 150 of FIG. 3G has been rotated as compare to display 150 of FIG. 3C. According to some configurations, the teleconference monitor view 320B is positioned near a top right corner of the display 150 when the device is in landscape orientation. As discussed above, the teleconference monitor view 320B can be positioned and/or sized at different locations. In some examples, the server module 136 determines the location based on the content being displayed by the selected category of functionality and/or an analysis of the display of content associated with the selected category of functionality. In addition to having default locations associated with a category of functionality, some configurations can include a first default location for landscape mode and a second default location for portrait mode.

FIG. 3H depicts the transition to the multi-tasking view 310 where multi-tasking content is concurrently displayed with a teleconference monitor view 330A. In the current example, the user has navigated to “chat” functionality that is provided by the teleconference system 102. In response to the chat functionality being selected, the teleconference monitor view 330A is illustrated within a menu section 350 of the chat menu bar. According to some configurations, instead of overlaying the teleconference monitor view over a portion of the content, the teleconference monitor view is integrated as part of the content that is displayed. For example, instead of displaying a solid banner within menu section 350, the teleconference system can display content obtained from one or more teleconference streams. In the current instance, the teleconference system 102 includes a display of the active presenter. In other examples, the teleconference system 102 can display content being presented within the teleconference and/or additional content.

Also illustrated within the menu section 350 is a display of core control elements 340. The controls 340 can be configured to control aspects of the teleconference session 104. For instance, a first button of the core controls 340 can disconnect the device 106(1) from the teleconference session 104. A second button of the core controls 340 can control the microphone of the device 106(1), i.e., a mute button. A third button of the core controls 340 can control the camera of the device 106(1), i.e., toggle the camera on or off. A fourth button of the core controls 340 can be used to add users to the session 104. In response to receiving the user actuation of the fourth button, a menu can be displayed enabling users to select other users to become meeting participants.

FIG. 3I depicts the transition to the multi-tasking view 310 in which a teleconference monitor view 320A displays content relating to an active presenter. In the current example, the user has selected “calendar” functionality that might be provided by the teleconference system 102 and/or provided by some other application. In response to the calendar functionality being selected, the calendar is displayed on display 150 along with the teleconference monitor view 320a. The teleconference monitor view 320a can include an image, an avatar, or a video of the active speaker or presenter of the teleconference session. In such embodiments, the location of the teleconference monitor view 320a can be based on the selection of the functionality, e.g., the calendar functionality, and/or the content displayed in association with the selected functionality.

FIG. 3J depicts the transition to the multi-tasking view 310 for displaying the calendar content along with a teleconference monitor view 320. As discussed above with regard to FIG. 3H content obtained from one or more teleconference streams can be incorporated into the display of content. In some examples, the content 360 can be incorporated within the content of the calendar and/or displayed as an overlay. In some examples, a portion of the content associated with the multi-tasking content can be displayed translucently such that at least a portion of the underlying content 360 (e.g., the content 360 of the teleconference monitor view 320) can be seen.

FIG. 3K depicts the transition to the multi-tasking view 310 in landscape mode for managing chat content 363. The multi-tasking view 310 and a teleconference monitor view 320 are configured and arranged to display content 362 (e.g., the chart) of the one or more teleconference streams concurrently with the chat content 363. As discussed above with regard to FIG. 3H and 3J, content obtained from one or more teleconference streams can be incorporated into the display of content 363, e.g., the chat content, associated with the multi-tasking view. In some examples, the content 362 for the teleconference monitor view 320 can be incorporated within the content of the calendar and/or displayed as an overlay. In the current example, a portion of the chat content 363 is displayed translucently to allow at least a portion of the underlying content 362 to also be displayed. In the current example, the content 362 (e.g., the chart) currently being displayed within the teleconference session 104 is presented on a display 150. In this example, selected items, e.g., the text boxes of the chat, are not translucent but the other items of the chat functionality, such as the chat UI background, are translucent. Such configurations can enable the shared content 362 of a teleconference session 104 to be displayed concurrently with the content 363 associated with the selected functionality. In some configurations, the system generates a first stream of a session 104, which can be displayed in a first user interface, e.g., a group of people or content shown in FIG. 3A. The system can also generate a second stream of teleconference data to render within the second graphical user interface, e.g., shown for example in FIG. 3J and 3K, wherein the second stream of teleconference data includes at least a portion of the first stream, e.g., one person or content.

FIGS. 3L, 3M, and 3N depict a teleconference monitor view 360 that includes a content display area 379 for a display of a presenter or content, and a “ME” display area 380. The ME display area 380 of the teleconference monitor view 360 includes an image, an avatar, or a video of the user and/or camera view of the client computing device 106(1) on which the teleconference session is playing. The ME display area 380 may be displayed as a miniaturized video or image screen having any suitable aspect ratio such as for example, 16:9, 4:3, 3:2, 5:4, 5:3, 8:5, 1.85:1, 2.35:1, or any aspect ratio deemed suitable in specific implementations. The ME display area 380 may include a pin (not shown) to pin the ME display area 380 to the teleconference monitor view 360. Any or all of the user interface elements described herein, such as the ME display area 380 may also include a pin to pin the corresponding user interface element to the display. In addition to displaying the “ME” content, the teleconference monitor view 360 also includes the content display area 379 for displaying a portion of one or more teleconference streams, such as the active presenter, and/or content currently being presented. FIG. 3L shows the teleconference monitor view 360 including a display of the current presenter in the teleconference (content display area 379) and a view of the user of client computing device 106(1) (ME display area 380).

FIG. 3M shows an avatar representing the current presenter in the content display area 379. In some configurations, the avatar representing the current presenter can have a graphical element, such as ring around the avatar or any other shaped graphical object that lights up or changes a display property (such as a color change) when the presenter is speaking. FIG. 3N shows the teleconference monitor view 360 in a rotated format, where the content display area 379 and the ME display area 380 are aligned vertically. Generally, in addition to being located in a predetermined position based on the techniques disclosed herein, the teleconference monitor view 360 can be sized, positioned and/or shaped in many different ways. In some examples, the user interface element(s) associated with the teleconference monitor view are sized and positioned such that the teleconference monitor view minimizes obscuring the display of the content associated with the other functionality.

FIGS. 3O, 3P, and 3Q depict the teleconference monitor view 360 positioned at different locations within the display 150. FIG. 3O shows the teleconference monitor view 360 displayed near the middle right of the display 150. In the example of FIG. 3O, the monitor view 360 includes a first content display area 379A and a second content display area 379B. The first content display area 379A shows the current presenter and the second content display area 379B shows another participant of the teleconference. In some configurations, in addition to showing the active presenter of the teleconference, one or more other content display areas are configured to show participants when the participant either reacts (e.g., suddenly moves, claps, cheers, and the like) or when a participant leaves or enters the view of the camera associated with the participant. According to some examples, one or more of the content display areas can be set to a persistent view such that the display area does not switch between different streams. In other examples, each of the content areas can change based on the change of the active presenter, changes in the content currently being presented, and/or detected changes associated with other participants in the teleconference.

FIG. 3P shows the teleconference monitor view 360(1) displayed near the bottom right of the display 150. In the example of FIG. 3O, the monitor view 360(1) includes a first content display area 379A and a second content display area 379C. The first content display area 379A shows the current presenter and the second content display area 379C shows a view of the content being presented.

FIG. 3Q shows the teleconference monitor view 360(2) displayed near the bottom right of the display 150 in addition to being sized larger than the teleconference monitor view 360(1). While one or two content display areas are illustrated in the figures, there may be more than two content display areas (e.g., three, four, . . . ). As disclosed herein, the teleconference system 102 and/or some other component or module can be configured to perform an analysis of the displayed content of the multi-tasking view 310 to identify an area of the screen that does not include content or to identify an area of the screen that does not include controls. In some configurations, the teleconference monitor view 360 can be dynamically positioned in an area of the screen that does not include content or to identify an area of the screen that does not include controls. Other areas, such as areas having a uniform color or a predetermined color, can be selected for positioning of the teleconference monitor view 360.

In addition, a server or client computer may combine the streams to generate teleconference data where the teleconference data can be configured to provide a primary display area for displaying a first stream of the teleconference data and a secondary display area for displaying a second stream of the teleconference data, as shown in the figures and described above. The teleconference data can be configured to cause at least one client computing device of the plurality of client computing devices to display the stage view when the user is not multi-tasking and to display the multi-tasking view when the user is determined to be multi-tasking.

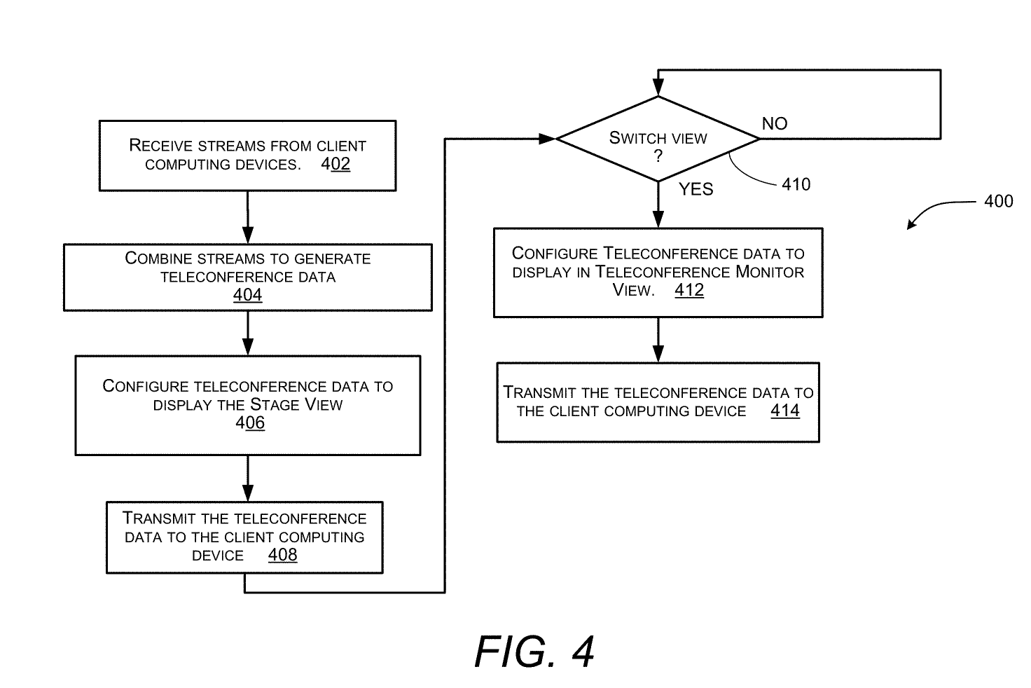

Turning now to FIG. 4, aspects of a routine 400 for presenting a teleconference monitor view on the display of a client computing device 106 are shown and described. It should be understood that the operations of the methods disclosed herein are not necessarily presented in any particular order and that performance of some or all of the operations in an alternative order(s) is possible and is contemplated. The operations have been presented in the demonstrated order for ease of description and illustration. Operations may be added, omitted, and/or performed simultaneously, without departing from the scope of the appended claims.

It also should be understood that the illustrated methods can end at any time and need not be performed in their entireties. Some or all operations of the methods, and/or substantially equivalent operations, can be performed by execution of computer-readable instructions included on a computer-storage media, as defined below. The term “computer-readable instructions,” and variants thereof, as used in the description and claims, is used expansively herein to include routines, applications, application modules, program modules, programs, components, data structures, algorithms, and the like. Computer-readable instructions can be implemented on various system configurations, including single-processor or multiprocessor systems, minicomputers, mainframe computers, personal computers, hand-held computing devices, microprocessor-based, programmable consumer electronics, combinations thereof, and the like.

It should be appreciated that the logical operations described herein are implemented (1) as a sequence of computer implemented acts or program modules running on a computing system and/or (2) as interconnected machine logic circuits or circuit modules within the computing system. The implementation is a matter of choice dependent on the performance and other requirements of the computing system. Accordingly, the logical operations described herein are referred to variously as states, operations, structural devices, acts, or modules. These operations, structural devices, acts, and modules may be implemented in software, in firmware, in special purpose digital logic, and any combination thereof.

For example, the operations of the routine 400 are described herein as being implemented, at least in part, by an application, component and/or circuit, such as the server module 136 in device 110 in FIG. 1 in the system 100 hosting the teleconference session 104. In some configurations, the server module 136 can be a dynamically linked library (DLL), a statically linked library, functionality produced by an application programing interface (API), a compiled program, an interpreted program, a script or any other executable set of instructions. Data and/or modules, such as the server module 136, can be stored in a data structure in one or more memory components. Data can be retrieved from the data structure by addressing links or references to the data structure.

Although the following illustration refers to the components of FIG. 1 and FIG.

2, it can be appreciated that the operations of the routine 400 may also be implemented in many other ways. For example, the routine 400 may be implemented, at least in part, or in modified form, by a processor of another remote computer or a local circuit, such as for example, the client module 130 in the client computing device 106(1). In addition, one or more of the operations of the routine 400 may alternatively or additionally be implemented, at least in part, by a chipset working alone or in conjunction with other software modules. Any service, circuit or application suitable for providing the techniques disclosed herein can be used in operations described herein.

Referring to FIG. 4, the routine 400 begins at 402, where the server module 136 receives one or more streams, such as a plurality of streams 142(1)-142(N) from corresponding client computing devices 106(1)-106(N). Users of each client computing device communicate a request to join the teleconference session 104 and for the server to communicate a media stream 142 once authorized to participate in the teleconference session 104. The server module 136 receives the streams 142 from each client computing device 106.

At step 404, the streams are combined to generate teleconference data 146 corresponding to a selected client computing device 106(1) having a display device 150(1). In some configurations, step 404 can involve an operation where a server or client computer can analyze the teleconference data or the streams to determine the presence of content. For instance, the server can determine when a client computing device is sharing content media, such as a file, an image of an application, an application share screen, or any other type of content.

At step 406, the teleconference data is configured to display a stage view as described with reference to FIG. 3A. In this example implementation, the stage view may be selected as a default view when the user is not multi-tasking. Generally, the stage view includes content from one or more of the streams 142(1)-142(N). In some configurations, the stage view can include a rendering of a plurality of streams of the teleconference data 146. For instance, any predetermined number of participants or content can be displayed, wherein the selection of the participants or content can be based on an activity level priority associated with each participant or content. In addition, the order of the participants or content can be based on an activity level priority associated with individual streams of the teleconference data 146 containing participants or content. An example of such a display is described herein and shown in FIG. 3A.

In configuring the teleconference session view, streams of the teleconference data may be arranged in a session view based on an activity level priority for streams associated with individual participant presenters. The video or shared content in the streams may be analyzed to determine an activity level priority for any stream of the teleconference data. The activity level priority, which is also referred to herein as a “priority value,” can be based on any type of activity including, but not limited to, any of the following:
1. participant motion—the extent to which a participant moves in the video may determine the participant's activity level. Participants in the process of gesturing or otherwise moving in the video may be deemed to be participating at a relatively high level in the teleconference.
2. participant lip motion—the video may be analyzed to determine the extent to which a participant's lips move as an indication of the extent to which the participant is speaking. Participants speaking at a relatively high level may be deemed to be participating at a corresponding relatively high level.
3. participant facial expressions—the participant's video may be analyzed to determine changes in facial expressions, or to determine specific facial expressions using pattern recognition. Participants reacting through facial expressions in the teleconference may be deemed to be participating at a relatively high level.
4. content modification—video of content being shared in the teleconference may be analyzed to determine if it is being modified. The user interface element corresponding to content may be promoted in rank in the secondary display area or automatically promoted to the primary display area if the video indicates the content is being modified.
5. content page turning—video of content being shared may be analyzed to determine if there is page turning of a document, for example, and assigned a corresponding activity level priority.
6. number of participant presenters having content in the primary display area—video of content being shared may be assigned an activity level priority based on the number of participants that have a view of the content in the primary display area or secondary display area.
7. participant entering teleconference session—streams from participants entering a teleconference may be assigned a high activity level priority. A priority value can be based on the order in which participants join a session.
8. participant leaving teleconference session—streams from participants entering a teleconference may be assigned a low activity level priority.

At step 408, the teleconference data 146 is transmitted to the selected client computing device 106(1) to display the teleconference data. Once displayed, the user may participate in the teleconference session 104 in the view formatted according to the teleconference session view. The user may then decide to multi-task and change the view provided by the teleconference session. The user may initiate one method for modifying the view by selecting one or more controls to select other functionality that is associated with the teleconference system and/or functionality associated with another application.

At decision block 410, the client computing device 106(1) provides an indication to the teleconference system 102 whether to switch views. In some configurations, the indication to switch views can be based on an input from a user selection of a graphical element, such as a button or a drop-down menu, for example. In some configurations, the indication can be based on a signal or data generated by a computing device detecting one or more conditions, such as the user navigating to another application or accessing different functionality provided by the teleconference system.

At step 412, a teleconference stream is generated to display as a teleconference monitor view. For instance, the teleconference monitor view can be similar to the displays presented in FIGS. 3B-3Q. At step 414, the teleconference stream is transmitted to the client device for display. As also discussed above, the server module 136, or some other component, can determine the location at which to position the teleconference monitor view. In some examples, the location is based on the selected category of functionality associated with the multi-tasking being performed by the user.

In some configurations, methods for determining a location of a teleconference monitor view, user interface element, or any other graphical user interface for displaying select streams of a teleconference can be based, at least in part, on functionality provided by one or more software applications. For illustrative purposes, individual software applications can include a module, a stand-alone executable application, or any other set of instructions separated by a distinct code delineation, such as a delineation of code between files.

For illustrative purposes, consider an example where a first category of functionality, i.e., the controls for managing the teleconference session, can be a part of a first software application. In addition, the first software application may also provide a second category of functionality, i.e., controls for managing a chat session. In the same example, a third category of functionality, i.e., web browsing functionality, can be part of a second software application. In this example, the routine for determining a location of the teleconference monitor view can be processed differently depending on the software application that is used.

In the present example, when a control command is received to transition from the teleconference session view to the chat session view, the system can determine a location for the teleconference monitor view based on a default location associated with a chat session functionality. Thus, if the selected category of functionality is provided by the same software application that is providing the teleconference session functionality, the location for the multi-tasking view is based on a default location associated with the selected category of functionality. For example, the location can be in the middle-right section of a user interface, in the upper right corner, or in any other location that is associated with the chat session functionality. By providing a default location for functionality that is in the same application providing the teleconference session functionality, processing power and other resources can be conserved since the computer is not analyzing content to determine a location for the teleconference monitor view.

In the same example, when the control command indicates a transition from the teleconference session view to a view for the web browsing functionality, e.g., in a separate software application, the system can determine the location based on an analysis performed on a displayed webpage, e.g., the displayed content. The location, for example, can be on or around a blank area of the webpage.

Although the techniques described herein have been described in language specific to structural features and/or methodological acts, it is to be understood that the appended claims are not necessarily limited to the features or acts described. Rather, the features and acts are described as example implementations of such techniques.

The operations of the example processes are illustrated in individual blocks and summarized with reference to those blocks. The processes are illustrated as logical flows of blocks, each block of which can represent one or more operations that can be implemented in hardware, software, or a combination thereof. In the context of software, the operations represent computer-executable instructions stored on one or more computer-readable media that, when executed by one or more processors, enable the one or more processors to perform the recited operations. Generally, computer-executable instructions include routines, programs, objects, modules, components, data structures, and the like that perform particular functions or implement particular abstract data types. The order in which the operations are described is not intended to be construed as a limitation, and any number of the described operations can be executed in any order, combined in any order, subdivided into multiple sub-operations, and/or executed in parallel to implement the described processes. The described processes can be performed by resources associated with one or more device(s) such as one or more internal or external CPUs or GPUs, and/or one or more pieces of hardware logic such as FPGAs, DSPs, or other types of accelerators.

All of the methods and processes described above may be embodied in, and fully automated via, software code modules executed by one or more general purpose computers or processors. The code modules may be stored in any type of computer-readable storage medium or other computer storage device. Some or all of the methods may alternatively be embodied in specialized computer hardware.

Conditional language such as, among others, “can,” “could,” “might” or “may,” unless specifically stated otherwise, are understood within the context presented that certain examples include, while other examples do not include, certain features, elements and/or steps. Thus, such conditional language is not generally intended to imply that certain features, elements and/or steps are in any way required for one or more examples or that one or more examples necessarily include logic for deciding, with or without user input or prompting, whether certain features, elements and/or steps are included or are to be performed in any particular example. Conjunctive language such as the phrase “at least one of X, Y or Z,” unless specifically stated otherwise, is to be understood to present that an item, term, etc. may be either X, Y, or Z, or a combination thereof.

Any routine descriptions, elements or blocks in the flow diagrams described herein and/or depicted in the attached figures should be understood as potentially representing modules, segments, or portions of code that include one or more executable instructions for implementing specific logical functions or elements in the routine. Alternate implementations are included within the scope of the examples described herein in which elements or functions may be deleted, or executed out of order from that shown or discussed, including substantially synchronously or in reverse order, depending on the functionality involved as would be understood by those skilled in the art. It should be emphasized that many variations and modifications may be made to the above-described examples, the elements of which are to be understood as being among other acceptable examples. All such modifications and variations are intended to be included herein within the scope of this disclosure and protected by the following claims.

The present disclosure includes the following examples.

### EXAMPLE 1

A method comprising: receiving one or more teleconference streams associated with a teleconference session; causing a display, on a display device, of a first graphical user interface associated with a first category of functionality; receiving an indication to dismiss the first graphical user interface based, at least in part, on identifying a change in selection from the first category of functionality to a second category of functionality associated with a second graphical user interface; displaying the second graphical user interface in response to the indication; determining a location to position a graphical user interface element within the second graphical user interface, wherein the location is based, at least in part, on the second category of functionality; and causing a display of the graphical user interface element within the second graphical user interface at the location, wherein the graphical user interface element comprises a rendering of the one or more teleconference streams, and wherein the graphical user interface element is concurrently displayed with a rendering of the content associated with the second category of functionality.

### EXAMPLE 2

The method of example 1, further comprising identifying an active presenter of the teleconference session and where the one or more teleconference streams includes one or more of video data of the active presenter or image data representing the active presenter.

### EXAMPLE 3

The method of examples 1 and 2, where the first category of functionality is provided by an application, the second category of functionality is provided by the application, and where determining the location of the graphical user interface element comprises setting the location to a default location associated with the second category of functionality.

### EXAMPLE 4

The method of examples 1 through 3, where: causing the display of the graphical user interface element includes overlaying the graphical user interface element on one or more other graphical user interface elements displaying the content associated with the second category of functionality.

### EXAMPLE 5

The method of examples 1 through 4, where the location of the graphical user interface element is determined by identifying areas of the second graphical user interface having less than a threshold level of content; and selecting the location based on areas of the second graphical user interface having less than a threshold level of priority.

### EXAMPLE 6

The method of examples 1 through 5, where the first category of functionality is provided by a first application, the second category of functionality is provided by a second application, and where determining the location of the graphical user interface element comprises analyzing content displayed within the second graphical user interface to determine one or more areas within the second graphical user interface to locate the graphical user interface element.

### EXAMPLE 7

The method of examples 1 through 6, where: determining the location to position the graphical user interface element includes one or more of identifying a first area of the display device that does not comprise a selectable user interface element, or identifying a second area of the display device that is one or more of a solid color, or does not include textual content; and setting the location of the graphical user interface element based at least in part on one or more of the first area or the second area.

### EXAMPLE 8

A method comprising: receiving one or more teleconference streams associated with a teleconference session; causing a display, on a display device, of a first graphical user interface associated with a first category of functionality; receiving an indication to dismiss the first graphical user interface based, at least in part, on identifying a change in selection from the first category of functionality to a second category of functionality associated with a second graphical user interface; displaying the second graphical user interface in response to the indication; determining a location to position a graphical user interface element within the second graphical user interface, wherein the location is based, at least in part, on a display of content within the second graphical user interface that is associated with the second category of functionality; and causing a display of the graphical user interface element within the second graphical user interface at the location, wherein the graphical user interface element comprises a rendering of the one or more teleconference streams, and wherein the graphical user interface element is concurrently displayed with a rendering of the content associated with the second category of functionality.

### EXAMPLE 9

The method of example 8, further comprising identifying an active presenter of the teleconference session and where the one or more teleconference streams includes one or more of video data of the active presenter or image data representing the active presenter.

### EXAMPLE 10

The method of examples 8 through 9, where the first category of functionality is provided by an application, the second category of functionality is provided by the application, and where determining the location of the graphical user interface element comprises setting the location to a default location associated with the second category of functionality.

### EXAMPLE 11

The method of examples 8 through 10, where: causing the display of the graphical user interface element includes overlaying the graphical user interface element on one or more other graphical user interface elements displaying the content associated with the second category of functionality.

### EXAMPLE 12

The method of examples 8 through 11, where the location of the graphical user interface element is determined by identifying areas of the second graphical user interface having less than a threshold level of content; and selecting the location based on areas of the second graphical user interface having less than a threshold level of priority.

### EXAMPLE 13

The method of examples 8 through 12, where the first category of functionality is provided by a first application, the second category of functionality is provided by a second application, and where determining the location of the graphical user interface element comprises analyzing content displayed within the second graphical user interface to determine one or more areas within the second graphical user interface to locate the graphical user interface element.

### EXAMPLE 14

The method of examples 8 through 13, where: determining the location to position the graphical user interface element includes one or more of identifying a first area of the display device that does not comprise a selectable user interface element, or identifying a second area of the display device that is one or more of a solid color, or does not include textual content; and setting the location of the graphical user interface element based at least in part on one or more of the first area or the second area.

### EXAMPLE 15

A system, comprising: one or more processing units; and a computer-readable medium having encoded thereon computer-executable instructions to cause the one or more processing units to: cause a first stream of teleconference data to be rendered within a first graphical user interface on a display; receive an indication to render a second graphical user interface, wherein the indication is based, at least in part, on identifying that a participant of a teleconference session has indicated to change from a first category of functionality to a second category of functionality; determine a location to position the second graphical user interface on the display, where the location is based, at least in part, on a display of content associated with the second category of functionality; generate a second stream of teleconference data to render within the second graphical user interface on the display, wherein the second stream of teleconference data includes at least a portion of the first stream; and cause the second stream of teleconference data to be rendered within the second graphical user interface on the display.

### EXAMPLE 16

The system of example 15, where the computer-readable medium includes encoded computer-executable instructions to cause the one or more processing units to receive the one or more teleconference streams and generate the first stream of teleconference data, where the first stream of teleconference data includes data associated with renderings for a first participant, a second participant, and content shared within the teleconference session.

### EXAMPLE 17

The system of examples 15 through 16, where the computer-readable medium includes encoded computer-executable instructions to cause the one or more processing units to identify an active presenter of the teleconference session and where the second stream of teleconference data includes one or more of video data of the active presenter or image data representing the active presenter.

### EXAMPLE 18

The system of examples 15 through 17, where the computer-readable medium includes encoded computer-executable instructions to cause the one or more processing units to identify content being shared within the teleconference session and where the second stream of teleconference data includes one or more of video data of at least a portion of the content being shared or image data of at a least a portion of the content being shared.

### EXAMPLE 19

The system of examples 15 through 18, where: determining the location to position the second graphical user interface includes setting the location to a default location associated with the second category of functionality.

### EXAMPLE 20

The system of examples 15 through 19, where: causing the second stream of teleconference data to be rendered comprises causing the second teleconference stream to be rendered within one or more graphical user interface elements associated with the second category of functionality.

### EXAMPLE 21

The system of examples 15 through 20, where the computer-readable medium includes encoded computer-executable instructions to cause the one or more processing units to: analyze content displayed within the third graphical user interface associated with the second category of functionality to determine one or more areas within the third graphical user interface to locate the second graphical user interface.

### EXAMPLE 22

The system of examples 15 through 21, where causing the second stream of teleconference data to be rendered comprises causing the rendering to occur within an area of the display that does not include a selectable user interface element.

We claim:

1. A method comprising:
receiving one or more teleconference streams associated with a teleconference session;
causing a display, on a display device, of a first graphical user interface associated with a first category of functionality;
receiving an indication to dismiss the first graphical user interface based, at least in part, on identifying a change in selection from the first category of functionality to a second category of functionality associated with a second graphical user interface;
displaying the second graphical user interface in response to the indication;
determining a location to position a graphical user interface element within the second graphical user interface, wherein the location is based, at least in part, on a display of content within the second graphical user interface that is associated with the second category of functionality; and
causing a display of the graphical user interface element within the second graphical user interface at the location, wherein the graphical user interface element comprises a rendering of the one or more teleconference streams, and wherein the graphical user interface element is concurrently displayed with a rendering of the content associated with the second category of functionality.

2. The method of claim 1, further comprising identifying an active presenter of the teleconference session and where the one or more teleconference streams includes one or more of video data of the active presenter or image data representing the active presenter.

3. The method of claim 1, where the first category of functionality is provided by an application, the second category of functionality is provided by the application, and where determining the location of the graphical user interface element comprises setting the location to a default location associated with the second category of functionality.

4. The method of claim 1, where:
causing the display of the graphical user interface element includes overlaying the graphical user interface element on one or more other graphical user interface elements displaying the content associated with the second category of functionality.

5. The method of claim 1, where the location of the graphical user interface element is determined by identifying areas of the second graphical user interface having less than a threshold level of content; and selecting the location based on areas of the second graphical user interface having less than a threshold level of priority.

6. The method of claim 1, where the first category of functionality is provided by a first application, the second category of functionality is provided by a second application, and where determining the location of the graphical user interface element comprises analyzing content displayed within the second graphical user interface to determine one or more areas within the second graphical user interface to locate the graphical user interface element.

7. The method of claim 1, where:
determining the location to position the graphical user interface element includes one or more of
identifying a first area of the display device that does not comprise a selectable user interface element, or
identifying a second area of the display device that is one or more of a solid color, or does not include textual content; and
setting the location of the graphical user interface element based at least in part on one or more of the first area or the second area.

8. A system, comprising:
one or more processing units; and
a computer-readable medium having encoded thereon computer-executable instructions to cause the one or more processing units to:
cause a first stream of teleconference data to be rendered within a first graphical user interface on a display;
receive an indication to render a second graphical user interface, wherein the indication is based, at least in part, on identifying that a participant of a teleconference session has indicated to change from a first category of functionality to a second category of functionality;
determine a location to position the second graphical user interface on the display, where the location is based, at least in part, on a display of content associated with the second category of functionality;
generate a second stream of teleconference data to render within the second graphical user interface on the display, wherein the second stream of teleconference data includes at least a portion of the first stream; and
cause the second stream of teleconference data to be rendered within the second graphical user interface on the display.

9. The system of claim 8, where the computer-readable medium includes encoded computer-executable instructions to cause the one or more processing units to receive the one or more teleconference streams and generate the first stream of teleconference data, where the first stream of teleconference data includes data associated with renderings for a first participant, a second participant, and content shared within the teleconference session.

10. The system of claim 8, where the computer-readable medium includes encoded computer-executable instructions to cause the one or more processing units to identify an active presenter of the teleconference session and where the second stream of teleconference data includes one or more of video data of the active presenter or image data representing the active presenter.

11. The system of claim 8, where the computer-readable medium includes encoded computer-executable instructions to cause the one or more processing units to identify content being shared within the teleconference session and where the second stream of teleconference data includes one or more of video data of at least a portion of the content being shared or image data of at a least a portion of the content being shared.

12. The system of claim 8, where:
determining the location to position the second graphical user interface includes setting the location to a default location associated with the second category of functionality.

13. The system of claim 8, where:
causing the second stream of teleconference data to be rendered comprises causing the second teleconference stream to be rendered within one or more graphical user interface elements associated with the second category of functionality.

14. The system of claim 8, where the computer-readable medium includes encoded computer-executable instructions to cause the one or more processing units to:
analyze content displayed within the third graphical user interface associated with the second category of functionality to determine one or more areas within the third graphical user interface to locate the second graphical user interface.

15. The system of claim 8, where:
causing the second stream of teleconference data to be rendered comprises causing the rendering to occur within an area of the display that does not include a selectable user interface element.

16. A method, comprising:
generating a first stream of teleconference data to be rendered within a first graphical user interface on a display;
communicating the first stream of teleconference data to a client computing device comprising a display device for displaying a first user interface displaying a rendering of the first stream within a stage view;
receiving a control command for causing a transition of the rendering of the stage view to a teleconference monitor view; and
in response to receiving the control command,
generating a second stream of teleconference data to render within a graphical user element on the display device;
determining a location to position the graphical user interface element on the display device, where the location is based, at least in part, on a display of content on the display device associated with a category of functionality; and
communicating the second stream of teleconference data to a client computing device for rendering the second stream within the graphical user interface element on the display device, wherein the graphical user interface element is positioned at the location.

17. The method of claim 16, further comprising identifying an active presenter of the teleconference session and where the second stream of teleconference data includes one or more of video data of the active presenter or image data representing the active presenter.

18. The method of claim 16, further comprising identifying content being shared within the teleconference session and where the second stream of teleconference data includes one or more of video data of at least a portion of the content being shared or image data of at a least a portion of the content being shared.

19. The method of claim 16, where determining the location to position the graphical user interface element on the display device includes one or more of
analyzing content displayed on the display device to determine one or more areas to locate the graphical user interface element, or
setting the location to a default location associated with the second category of functionality.

20. The method of claim 16, where:
generating the second stream of teleconference data to render within the graphical user interface element on the display device comprises generating the second stream of teleconference data to be rendered within one or more graphical user interface elements associated with a display of content associated with the second category of functionality.
